(19) United States
(12) Patent Application Publication
(10) Pub. No.: US 2015/0062878 A1
(43) Pub. Date: Mar. 5, 2015

(54) Adjustable Kiosk

(71) Applicant: Kio-Structures Ltd., Spinningfields (GB)

(72) Inventors: Paul Danson, Cheadle (GB); Riva Danson, Spinningfields (GB); Clare Parkinson, Spinningfields (GB)

(73) Assignee: Kio-Structures Ltd., Spinningfields (GB)

(21) Appl. No.: 14/012,813

(22) Filed: Aug. 28, 2013

(51) Int. Cl. G09F 13/04

(52) U.S. Cl. CPC G09F 13/04
USPC 362/145; 29/592.1

(57) ABSTRACT

A kiosk which has an inner work or exhibition area, the kiosk comprising a shell constructed from a plurality of panels 18, and a lighting array 48 in the shell which is used to alter the appearance of the kiosk.

The present invention relates to kiosks and in particular a kiosk that can be adapted to create a usable space for a variety of different uses.

Kiosks are a housing structure used for the permanent or temporary provision of a facility such as the sale of goods or refreshments, or as an exhibition stand. They are frequently located at for example sporting and entertainment events. Kiosks are often oblong boxes with a serving hatch and are not especially aesthetically pleasing and are not readily adaptable to blend or meet the requirements of a particular event. For example, a sporting venue may host many different types of event, the home team may choose to decorate a kiosk with their logo and team colours. However, if the venue is used by a different team or the sporting event held has rules which prohibits the use of the owners colours or has a requirement for their own branding, it is not an easy matter to conceal a traditional kiosks appearance. Also over time the use of a kiosk may vary and the traditional box like kiosk cannot be easily modified to adapt its use, often requiring complete replacement.

It is an object of the present invention to provide a kiosk which overcomes or alleviates the aforementioned disadvantages.

It is a further object to provide a kiosk whose appearance is readily adaptable to suit a change in requirements for its use.

In accordance with a first aspect of the present invention there is provided an adaptable kiosk which has an inner work or exhibition area contained in a shell, the shell comprising a plurality of panels, each panel having a first surface and a second surface and a lighting array between the first and second surfaces, wherein at least one surface is translucent.

A cavity may be provided between the first and second surface, the lighting array being located in the cavity.

In a preferred embodiment the translucent surface is on the exterior of the surface of the shell and the other surface may comprise an opaque surface facing into the cavity. The opaque surface may be reflective.

Control means may be provided to adjust the lighting array. The adjustment may be at least one of colour, intensity, and pattern. The lighting array may comprise separately adjustable elements and the control means may have means to adjust those elements independently.

A surface of a panel may be adjustable. The adjustment may comprise means to provide a screen over a surface of the panel. The screen may comprise at least one of filter, a variable filter, a pattern and an opaque screen.

The panel may comprise two separable panels one comprising the first surface, the other the second surface.

In a preferred embodiment the kiosk is modular and the panels can be at least one of removed, replaced and adjusted. The shell may have a ball like shape and in a preferred embodiment is spherical.

The panels may extend between two support structures comprising a roof and a base.

In accordance with a second aspect of the present invention there is provided a method of changing the appearance of an adaptable kiosk comprising providing a lighting array in the shell of the kiosk, the shell having a translucent surface, the method comprising the step of adjusting the array to alter the appearance of the kiosk.

In a preferred embodiment the method comprises the step of changing the outer appearance of the kiosk and the shell has a translucent outer surface, the step of adjusting being to alter the outer appearance of the kiosk.

The method may comprise at least one of adjusting the colour, intensity and pattern of light provided by the array. The method may include applying different adjustments to different section of the array.

The adjustment may comprise at least partial covering the shell with a screen. The screen may be opaque or include a filter or have a patterned surface.

By this means the outer and/or inner appearance of the kiosk can be easily changed to display the colours and logo of a particular sports team or event.

In a preferred embodiment, the kiosk has a support frame, a base and a top to the kiosk each with means to selectively mount the support frame there between, wherein the frame has means to mount the panels therein. The means to selectively mount may comprise a ring beam.

The frame may comprise an inner and an outer frame structure which can be fastened together to retain the panels. The frame may comprise at least a plurality of separate support struts which extend between the top and base, a panel may be mounted between adjacent struts.

The frame may further comprise a tie beam which extends between two adjacent struts. At least a partial ring of such beams may be provided about the periphery of the kiosk. More than one tie-beam may extend between two adjacent struts. Separate panels may be mounted between the struts and be separated and supported by a tie-beam. A support strut may terminate at a tie beam.

At least one panel may be omitted to form an opening in the kiosk. A moveable cover may be mounted to the opening to selectively seal the opening. The cover may be hinged to the frame and constitute a hatch cover or door. At least more than one panel is omitted and the frame is constructed to support the kiosk about the opening.

The means to support the opening may comprise at least one of a tie bar and support strut.

Inner wall panels may be mounted inside the kiosk, the inner wall panels having a curved structure to lie adjacent the interior of the support frame. A cavity may be provided between the inner wall panels and the wall panels, the cavity may comprise a lighting means. At least one or a portion of the wall panels are translucent.

By way of example only specific embodiments of the present invention will now be described with reference to the accompanying drawings, in which:

FIG. 1 is a perspective view of a kiosk constructed in accordance with one embodiment of the of the present invention;

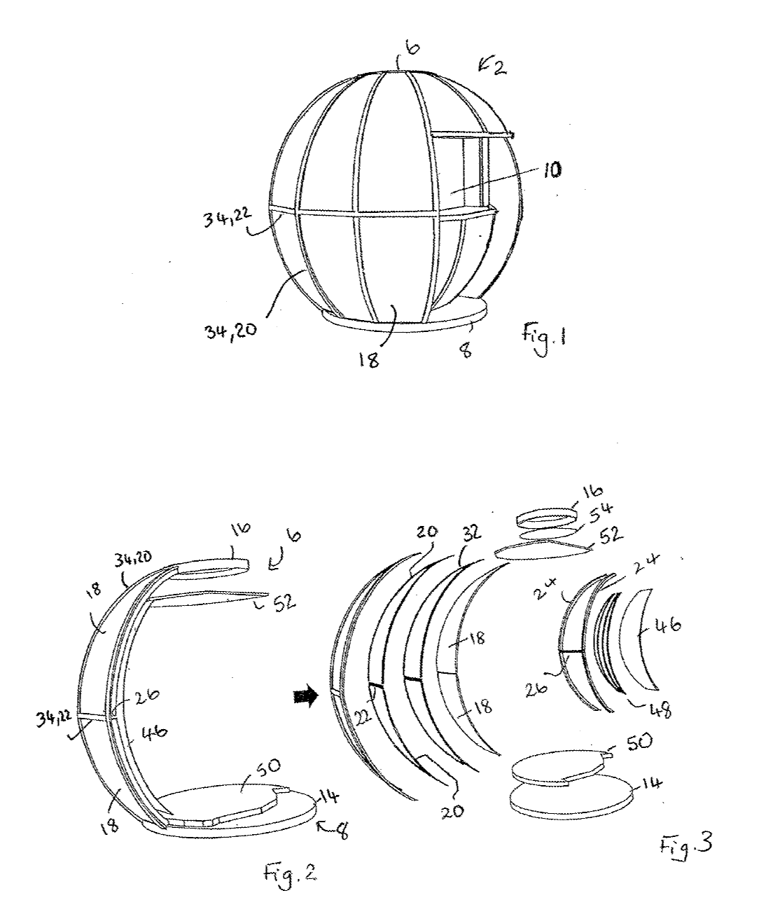

FIG. 2 is a partial schematic view showing an individual wall segment of the kiosk of FIG. 1 and its attachment to the roof and base section of the kiosk;

FIG. 3 is an exploded view of the structure of FIG. 2;

FIG. 4 is a detail of the wall segment of FIG. 2;

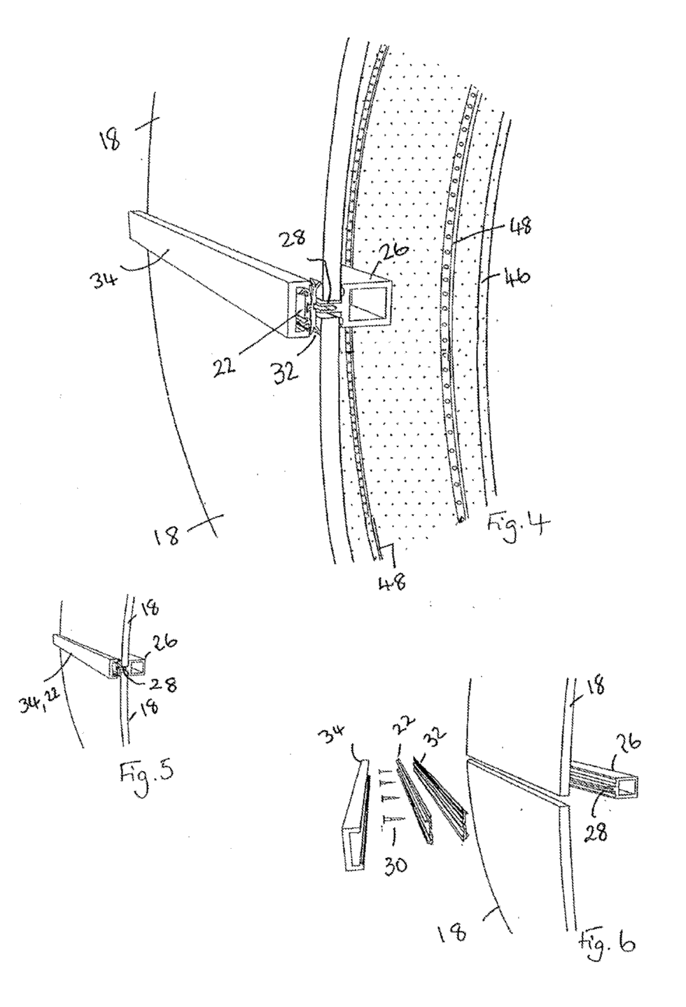

FIG. 5 is similar to the view of FIG. 4 but with the inner wall panel omitted;

FIG. 6 is an exploded view of the structure of FIG. 5;

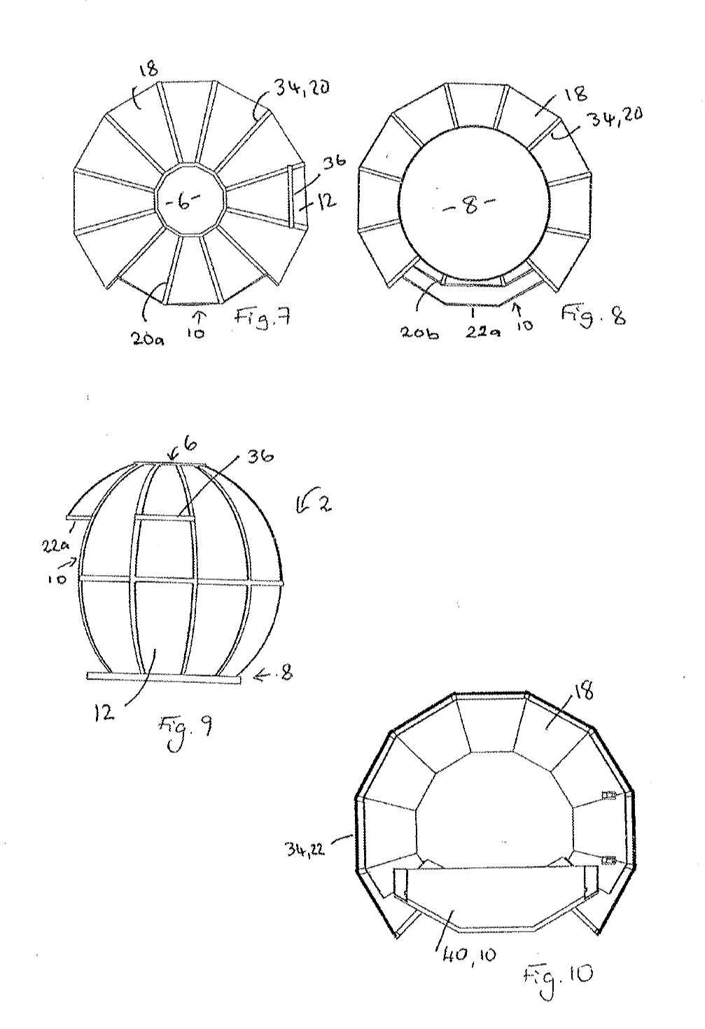

FIG. 7 is a plan view of the kiosk of FIG. 1;

FIG. 8 is a reverse plan view of the kiosk of FIG. 1;

FIG. 9 is a side elevation of the kiosk of FIG. 1, showing the door in a closed condition;

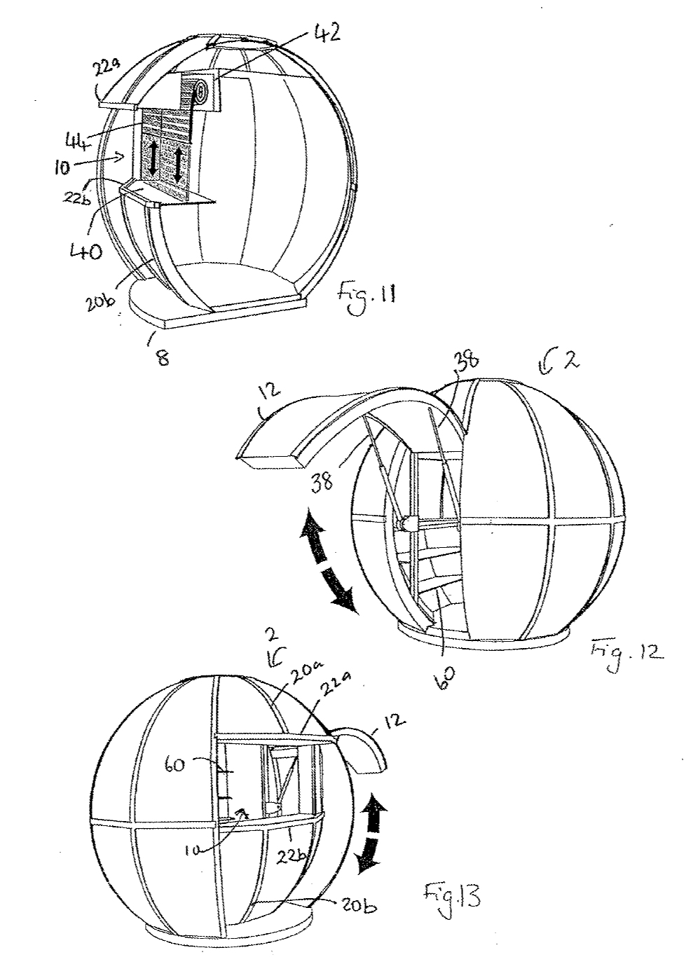

FIG. 10 is a transverse sectional view of the kiosk illustrating the counter region from above;

FIG. 11 is a longitudinal sectional view of the kiosk to show the mounting and operation of the shutter; and

FIG. 12 is a side view of the kiosk showing the door in an open condition and optional shelving installed.

FIG. 13 is a front view of the kiosk with the door in an open condition and optional shelving installed.

In a first embodiment of kiosk 2, as illustrated, the kiosk 2 has a substantially spherical shape and a hollow interior. The kiosk 2 has a modular construction comprising a plurality of convex wall segments 4 which extend between a roof section 6 and a base section 8. The kiosk 2 also comprises a serving hatch 10 and door 12.

The base section 8 comprises, as best illustrated in FIGS. 2 and 3, a planar base comprising a construction ring beam 14 which provides a stable foundation for the kiosk 2. The roof section 6 also comprises a ring beam 16. The various wall segments are mounted between the roof and base ring beams 16, 14. The wall segments comprise individual wall panels 18 mounted in a frame.

The frame comprises a plurality of outwardly curved longitudinal outer struts 20 which extend between the roof 6 and base 8 and are bolted at each of their longitudinal ends to a respective ring beam 16, 14. The frame also includes a plurality of outer tie beams 22 which extend in a ring about the outer circumference of the kiosk and interconnect the outer struts 20. Corresponding inner struts 24 and tie beams 26 are provided which inner struts 24 extend and are fixed between the roof and base panels 6, 8 on the interior of the kiosk and align with the outer struts 20. The inner tie beams 26 similarly extend in a ring about the interior of the kiosk 2 and align with the outer tie beams 22. The inner and outer tie beams 26, 22 and the inner and outer struts 24, 20 are respectively fastened together and form a frame for the infill and capture of individual wall panels 18. An individual wall segment comprises two wall panels 18 mounted between two adjacent struts 20, 24 and fixed by a tie beam 22, 26.

As best illustrated in FIGS. 5 and 6, the inner tie beams 26 has a lip 28 which extends towards the outer tie beam 22. A wall panel 18 is mounted on the lip 28 and a further wall panel 18 is mounted to the underside of the lip 28. The outer tie beam 22 is fastened to the inner tie beams 26 using fasteners 30 to connect the outer tie beam 22 to the inner tie beam 24 via its lip 28, which lip 28 extends between the panels 18. A gasket 32 is disposed between the outer tie beam 22 and the panels 18 to provide a seal between the inner and outer tie beams 26, 22 and hermetically seals the joint between the panels 18.

An outer cover or facia 34 is provided which covers the outer tie beam 22 to cover the frame members. The struts 20, 24 are connected in a similar fashion with fasteners 30, gaskets 22 and facias 34 and thereby capture the wall panels 18 therebetween.

The kiosk 2 is adaptable by adjustment of individual panels 18. In the illustrated embodiment a door 12 and serving hatch 10 are provided. To provide a door 12 as best illustrated in FIGS. 7, 9, 12 and 13, an individual wall segment is provided with a moveable portion. In this embodiment a hinge mechanism 36 is connected between two outer struts 20 and the panels connected below the hinge 36 constitute the door 12 and are moveable out of the body of the kiosk 2 to provide a door or entrance into the kiosk. To this end a pair of sliding mounting brackets 38 are provided to support the door 12 as it is lifted radially outwardly from the kiosk 2 to open the door and to support the door as it is returned to its original position to close the kiosk 2.

The individual wall segment can also be modified to provide a serving hatch 10. In the illustrated embodiment, as best illustrated in FIGS. 1 and 7 to 11 and 13, three individual wall segments have been modified to provide an opening in the wall of the kiosk 2 to form a serving hatch. These struts are each divided into two sections, separated by the hatch opening 10. The upper most section 20a connects to the roof section 6 and extends towards the base section 8 but terminate at the top 10a of the hatch opening 10 and are interconnected at this location by a tie beam 22a. The lower section of these struts 20b extend from the bottom edge 10b of the hatch opening 10 to the base section and are inset with respect to the upper section of the struts and are connected at the lower periphery of the opening by a further tie beam 22b, which is also inset with respect to the tie beams 22 interconnecting the struts 20 of the outer wall. Wall panels 18 are mounted in the frame openings above and below the hatch opening. A counter 40 is mounted to the further tie beam 10b at the lower peripheral edge 10b of the opening 10. A mounting bracket 42 is mounted behind the panels 18 above the opening 10. A shutter 44 is mounted to the bracket 42, which can be selectively drawn down to the counter 40 to close and seal the opening 10. As described previously the various wall panels are captured between inner and outer struts and inner and outer tie beams.

Interior wall panels 46 are additionally mounted inside the kiosk 2, as best illustrated in FIGS. 2, 3 and 4. The interior wall panels 46 curve outwardly and conceal the inner struts 24 and tie beams 26 of the frame. The interior wall panels 46 are not flush mounted but are mounted to provide a cavity between the interior wall panels 46 and the outer wall panels 18. A lighting arrangement 48 is provided in this cavity. An internal floor 50 is provided over the base ring beam 14 and a ceiling panel 52 is also provided to cover and conceal the roof ring beam 16.

The lighting arrangement 48 can be arranged to be multifunctional. The inner and outer wall panels 46, 18 can be adapted and changed as required.

In a first arrangement the interior wall panels 46 have a reflective surface facing the cavity and the outer wall panels 18 are at least partly translucent, such that light from the lighting arrangement is transmitted to the exterior of the kiosk 2 lighting up the exterior of the kiosk. Control means, not illustrated, can be provided to adjust and alter the light provided. For example, the colour of the light can be changed, the intensity of the light, the lighting arrangement could show a number of colours or shades to provide at least one of a pattern, picture or message and a light show may be provided. The control means may comprise means to input a change to the display to enable a user to select or design an illuminated appearance to the kiosk. Screens (not illustrated) may be provided which can fit to the panels to change the appearance of an individual panel, for example an opaque screen can prevent light shining through a specific panel, or the screen may contain a filter or have a cut out pattern to adjust the light through that panel.

Whilst light has been described as being provided to the exterior of the kiosk, the light may also or instead be provided to the interior of the kiosk, the reflective surface of the interior panels 46 may be omitted or be selectively removable to enable light to transmit into the interior of the kiosk. The exterior panels 18 may be provided with an inwardly facing reflective surface, or screens may provide this function by covering at least a portion of the exterior panels.

The modular nature of the kiosk enables the panels to be easily changed and as such their function and appearance to be changed. The panels could be touch sensitive such that a pattern can be provided and wiped by direct interaction with the panels. The facias covering struts and tie beams could also be easily changed to provide a different appearance. Whilst the facias 34 have been described as being mounted to the outside, they could also provide a covering to the inside to conceal the interior struts and beams.

The modular nature of the kiosk enables individual panels to be removed and changed. Also although interior wall panels have been described, these two could be omitted and the exterior wall panels could be provided as double glazed units with a lighting arrangement inside.

A suitable lighting arrangement could be an array of LEDs and/or a digital screen facility enabling a public display of video, graphics, text, and captured images, and which may have a touch screen capability.

The door 12 has been described as an upwardly rotating, however, other arrangements could be provided, for example the door could be hinged along one side and open inwards or outwards. The door could have a slidable mounting to enable it to be moved across the exterior or interior of the hatch to cover and open the door opening whilst only a single wall segment has been described as providing an opening for a door, the door could comprise several wall segments, or part of segments and open the kiosk along one side to provide a walk in arrangement to facilities provided in the interior of the kiosk.

Whilst the hatch has been described as spanning three wall segments, the hatch could have a different arrangement, in that it could span more or fewer segments or part segments, or it could be omitted. In the described embodiment the wall section below the hatch has been described as being inset, the hatch may instead be fully flush with the exterior, or may stand proud. The hatch may be omitted.

As best illustrated in FIGS. 12 and 13 shelving 60 may be constructed inside the kiosk, for example below the counter or on the interior walls.

Whilst a roll-type shutter has been illustrated, the shutter could comprise other means such as a removable or hinged panel.

The roof section may be adaptable, as mentioned previously the roof section comprises at least as ring beam and a ceiling panel may be provided which can be changeable. The ceiling panel 52 may be opaque or transparent, or provided with screens to alter its appearance. A roof panel 54 may also be provided to provide protection to the interior of the kiosk. This too may be adaptable. The roof and ceiling panels 52, 54 may be selectively removable or omitted to provide for example a flue, the connection of an extraction or a chiller unit. A ring may be provided (not illustrated), on the roof to enable connection of a lifting mechanism to lift and relocate the kiosk in its fully assembled condition.

A shroud (not illustrated) may be provided to selectively cover the exterior of the kiosk. This may be provided in the roof or base section and may be deployed to cover the exterior.

Whilst separate frame members and panels held within the frame members have been described it is to be understood that a panel and frame could be moulded together and connected with an adjacent panel when constructing the kiosk, or the panel could have means to connect to an adjacent panel to provide a more homogeneous surface.

In the described embodiment the segments comprise two panels. However, each segment could comprise one panel or more than one panel. The various segments forming the kiosk could each comprise different numbers of panels.

Whilst a spherical shape has been described other shapes are envisaged, for example other ball shapes such as that of a rugby ball, or other geometrical shapes, for example pyramid, cubes, hexagons, star shapes etc.

The modular nature of the designs enables easy manufacture, transport and assembly. Furthermore, the shape and function can be adjusted in situ to provide doors, hatches and appearance as required by altering the panels or adjusting their appearance. Additional features may be fixed to the frame, for example the ear, eyes and nose of a cartoon character, either by changing panels or clipping to the kiosk.

One or more of the panels could be replaced by solar panels, to provide a source of renewable energy. The panels could be adapted to filter incoming light to for example provide a light screen to reduce UV radiation.

The interior panels could be omitted and the lighting arrangements provided against the exterior panels or within the exterior panels. A projection unit may be provided to transmit the light around and/or through the panels.

A variety of materials could be used to construct the kiosk for example aluminium or other suitable weight bearing beams for the various frame members, the gasket could be rubber or elastomeric, the cover or facia could also be aluminium or plastics, the panels could be glass, metal, glass reinforced plastics, plastics etc.

It will of course be understood that the invention is not intended to be restricted to the details of the above embodiment which is described by way of example only.

1. An adaptable kiosk which has at least one of an inner work and exhibition area contained in a shell, the shell comprising a plurality of panels, each panel having a first surface and a second surface and a lighting array between the first and second surfaces, wherein at least one surface is translucent.

2. A kiosk according to claim 1, wherein a cavity is provided between the first and second surface, the lighting array being located in the cavity.

3. A kiosk according to claim 1, wherein the translucent surface is on the exterior of the surface of the shell.

4. A kiosk according to claims 1, wherein one surface is translucent and the other surface comprises an opaque surface facing into the cavity.

5. A kiosk according to claim to claim 1, wherein the one surface is translucent and the other surface comprises an opaque surface facing into the cavity and the opaque surface is reflective.

6. A kiosk according to claim 1, wherein the lighting array comprises at least one of the following digital screen facility and a digital screen facility with touch screen capability.

7. A kiosk according to claim 1, wherein a control means is provided to adjust the lighting array, the adjustment by the control means being at least one of colour, intensity, and pattern.

8. A kiosk according to claim 1, wherein the lighting array comprises separately adjustable elements.

9. A kiosk according to claim 1, wherein a surface of a panel is adjustable.

10. A kiosk according to claim 1, wherein a surface of a panel is adjustable, and the panel adjustment comprises means to provide a screen over a surface of the panel, wherein the screen comprises at least one of a filter, a variable filter, a pattern and an opaque screen.

11. A kiosk according to claim 1, wherein the panel comprises two separable panels one comprising the first surface, the other the second surface.

12. An adaptable kiosk which has at least one of an inner work and exhibition area contained in a shell, the shell comprising a plurality of panels, each panel having a first surface and a second surface and a lighting array between the first and second surfaces, wherein at least one surface is translucent, wherein the kiosk is modular and the panels are adapted to be at least one of removable, replaceable and adjustable.

13. A kiosk according to claim 12, wherein the shell has at least one of a ball like shape and a substantially spherical shape.

14. A kiosk according to claim 12, wherein the panels extend between two support structures comprising a roof and a base.

15. A kiosk according to claim 12, wherein the panels extend between two support structures comprising a roof and a base, and wherein the kiosk has a support frame, the base and the roof to the kiosk each having means to selectively mount the support frame there between, wherein the support frame has means to mount the panels therein.

16. A kiosk according to claim 12, wherein the panels extend between two support structures comprising a roof and a base, and wherein the kiosk has a support frame, the base and the roof to the kiosk each having means to selectively mount the support frame there between, wherein the support frame has means to mount the panels therein, and wherein the means to selectively mount the panels comprises a ring beam, and the support frame also comprises an inner and an outer frame structure which can be fastened together to retain the panels, the support frame further comprising at least a plurality of separate support struts which extend between the top and base, wherein a panel is mountable between adjacent struts, and the support frame also comprises a tie beam which extends between two adjacent struts, wherein at least a partial ring of such tie beams is provided about the periphery of the kiosk, and more than one tie-beam extends between two adjacent struts, and wherein separate panels are mounted between the struts and are separated and supported by a tie-beam, and wherein a support strut may terminate at a tie beam.

17. A kiosk according to claim 12, wherein at least one panel can be selectively omitted to form an opening in the kiosk.

18. A kiosk according to claim 12, wherein at least one panel can be selectively omitted for an opening in the kiosk, and a movable cover is mountable to the opening to selectively seal the opening, the cover being mountable to the shell and constitutes at least one of hatch cover and door.

19. A kiosk according to claim 12, wherein at least more than one panel is selectively omitted to form an opening in the kiosk and the shell is constructed to support the kiosk about the opening.

20. A kiosk according to claim 12, wherein at least more than one panel is selectively omitted to form an opening in the kiosk and the shell is constructed to support the kiosk about the opening, and wherein inner wall panels are mounted inside the kiosk, the inner wall panels having a curved structure to lie adjacent the interior of the support frame, and wherein a cavity is provided between the inner wall panels and the wall panels, and the cavity comprises said lighting array, wherein at least one portion of the panels are translucent.

21. A method of changing the appearance of an adaptable kiosk which has at least one of an inner work and exhibition area contained in a shell, the shell comprising a plurality of panels, each panel having a first surface and a second surface and a lighting array between the first and second surfaces, wherein at least one surface is translucent, comprising the step of adjusting the array to alter the appearance of the kiosk by at least one of following:
Adjusting at least one colour of at least part of the array;
Adjusting the pattern of light provided by at least part of the array;
Adjusting the intensity of the light of at least part of the array; and
Covering at least part of the shell with a screen, which screen includes at least one of an opaque surface, a filter and a patterned surface.

22. A method according to claim 20, wherein the method includes applying different adjustments to different sections of the array.
